(19) United States
(12) Patent Application Publication
(10) Pub. No.: US 2017/0032709 A1
(43) Pub. Date: Feb. 2, 2017

(54) ANTI-FORGERY LABEL USING RANDOM PROTRUDING ELEMENTS AND METHOD FOR MANUFATURING THE SAME

(71) Applicants: Fu-Pi Pao, Taipei City (TW); San-Yuan Wu, Taipei City (TW); Kuan-Ying Pao, Taipei City (TW)

(72) Inventors: Fu-Pi Pao, Taipei City (TW); San-Yuan Wu, Taipei City (TW); Kuan-Ying Pao, Taipei City (TW)

(73) Assignee: SENSE DIGITAL CO., LTD., Taipei City (TW)

(21) Appl. No.: 15/291,059

(22) Filed: Oct. 11, 2016

Related U.S. Application Data
(63) Continuation-in-part of application No. 14/466,910, filed on Aug. 22, 2014, now abandoned.

(30) Foreign Application Priority Data
Sep. 14, 2013 (TW) 102133306

(51) Int. Cl. G09F 3/00; G09F 3/10

(52) U.S. Cl. CPC G09F 3/0292; G09F 3/10; G09F 2003/0257

(57) ABSTRACT

An anti-forgery label using random protruding elements and a method for manufacturing the same. A substrate with a printed layer thereon is provided. An adhesive layer is coated on the printed layer, and a plurality of protruding elements are randomly distributed and adhered on the printed layer the adhesive layer. The surfaces of the printed layer and the protruding elements are covered with a light-permeable overcoat layer. A corresponding engaging region is formed in each of the protruding elements where it touches the overcoat layer, and a gap region is formed between the overcoat layer and the adhesive layer in proximity to each of the protruding elements. As such, randomly distributed tactile and visual identification features and irregular deformed identification regions are formed.

### BACKGROUND OF THE INVENTION

1. Field of the Invention

The invention relates to anti-forgery labels using random protruding elements and method for manufacturing the same, and more particularly, to anti-forgery labels using random protruding elements and method for manufacturing the same that provides randomly distributed protruding elements on the labels and irregularly deformed identification regions between the protruding elements and the substrate of labels to simultaneously offer multiple tactile and visual identification features.

2. Description of the Prior Art

Conventional carrier structures (labels) with anti-forgery identification features, for example, as seen in CN Patent Application No. 97126167.9 titled “NATURAL ANTI-FORGERY METHOD”, are made into fixed-sized (square, circular or other shapes) sheets from natural materials such as wood or stones. Each of these inherently characteristic sheets is individually assigned with a random number using a computer, and then the number is printed on the sheet. Then, the textures and patterns of the sheets are scanned and filed for future inquiries. This type of identification technique is based on the texture of the natural materials (e.g. wood or stone). However, under the current manufacturing environment with advanced photographic reproduction techniques, the fact that this type of identification method relies simply on visual identification of the features may not achieve the anticipated anti-forgery effect.

CN Patent Application No. 99801139.8 titled “STRUCTURAL TEXTURE ANTI-FORGERY METHOD” uses materials having unambiguous and random structural textures as anti-forgery identification objects that utilize the random structural textures as anti-forgery information. The anti-forgery information are scanned or recorded with a scanning device and stored in a computer identification database. Consumers may obtain information about the structural textures via communication tools such as phones, faxes or networked computers to verify the genuineness of the texture information of the products. The abovementioned random structural texture refers to an overall random texture formed by artificial carrier structures within a carrier. For example, filaments are added into paper pulp in which the distribution of the filaments is used as anti-forgery information. However, this type of anti-forgery labels can be counterfeited by providing similar visual effects of the features using the current printing (including stamping) techniques, such that an inquirer may find it difficult to distinguish. between a printed counterfeit and filaments unless the filaments are stripped off the carrier. Doing so requires time and effort and may easily damage the anti forgery label.

Moreover, in CN Patent Application No. 200910135421.4 titled “ANTI-FORGERY METHOD OF STRUCTURAL TEXTURE”, an anti-forgery mark is numbered and provided with a random texture given by angle-dependent color-shifting fibers. The feature of this random texture and the number are stored in a database for consumers to verify the genuineness of the random texture feature. Since it is impossible to counterfeit the angle-dependent color-shifting fibers by printing, the anti-forgery effectiveness of this type of texture is largely improved.

In addition, U.S. Pat. No. 6,755,350B2 titled “SENSUAL LABEL” uses particles to create a tactile sensation, but its randomness is rather simple. With methods such as 3D printing, similar appearances can still be counterfeited. In view of the shortcomings in the prior art, the present invention is proposed to provide improvements that address these shortcomings.

### SUMMARY OF THE INVENTION

One main objective of the present invention is to provide an anti-forgery label using random protruding elements and the method for manufacturing the same that offers multiple tactile and visual identification mechanisms.

Another main objective of the present invention is to provide an anti-forgery label using random protruding elements and the method for manufacturing the same that randomly provides protruding elements and irregular deformed identification regions during the manufacturing process.

In order to achieve the above objectives and effects, an anti-forgery label using random protruding elements is provided, which may include: a substrate with a printed layer thereon; an adhesive layer coated on the printed layer of the substrate; one or more protruding elements randomly disposed and adhered on the printed layer of the substrate with the adhesive layer; and a light-permeable overcoat layer covering the surfaces of the printed layer of the substrate and the protruding elements, wherein a corresponding engaging region is formed in each of the protruding elements where the respective protruding element touches the overcoat layer, and a gap region is formed between the overcoat layer and the adhesive layer in proximity to each of the protruding elements. The gap region refer to a hollow region resulting from the height difference between each of the protruding elements and the substrate surface after the overcoat layer is assembled. In addition, as the overcoat layer is a light-permeable material, variations in light transmittance and thus visual differences are created between the gap regions and the substrate. Meanwhile, the areas where the overcoat layer overlying the hollow regions (i.e. the gap regions) will have different tactile sensation compared to the substrate and the protruding elements. It should be noted that the gap regions are irregular regions formed as a result of the lamination process of the overcoat layer, they are not elements with fixed shapes that can be prepared in advance and controlled, making replication more difficult. As such, randomly provided tactile and visual identification features and irregular deformed identification regions can be provided.

In order to achieve the above objectives and effects, a method for manufacturing an anti-forgery label using random protruding elements is provided, which may include the following steps of:

providing a substrate with a printed layer thereon;

coating an adhesive layer on the printed layer of the substrate;

randomly providing and adhering one or more protruding elements on the printed layer of the substrate with the adhesive layer;

covering the surfaces of the printed layer of the substrate and the protruding elements with a light-permeable overcoat layer;

forming a corresponding engaging region in each of the protruding elements where the respective protruding element touches the overcoat layer; and

forming a gap region between the overcoat layer and the adhesive layer in proximity to each attic protruding elements.

In the above structure, a printed area is provided on the surface of the overcoat layer, and a deformed area is formed where the printed area overlaps each of the engaging regions.

In the above structure, the protruding elements are regular independent geometric three-dimensional elements or irregular independent three-dimensional elements.

In the above structure, some of the protruding elements further crisscross, overlap or are in proximity to one another to form the gap regions in communication with one another between these protruding elements.

In the above structure, the adhesive layer further includes pressure-sensitive particles.

The accomplishment of this and other objectives of the invention will become apparent from the following description and its accompanying drawings of which:

### BRIEF DESCRIPTION OF THE DRAWINGS

FIG. 1 is an isometric view of a preferred embodiment in accordance with the present invention.

FIG. 2 is a cross-sectional isometric view of the preferred embodiment in accordance with the present invention.

FIG. 3 is a flowchart illustrating a manufacturing method in accordance with a preferred embodiment the present invention.

FIG. 4 is an exploded view of the preferred embodiment in accordance with the present invention.

FIG. 5 is an enlarged view of parts of the preferred embodiment in accordance with the present invention.

FIGS. 6a to 6f are cross-sectional views of different protruding elements in accordance with the present invention.

### DETAILED DESCRIPTION OF THE PREFERRED EMBODIMENT

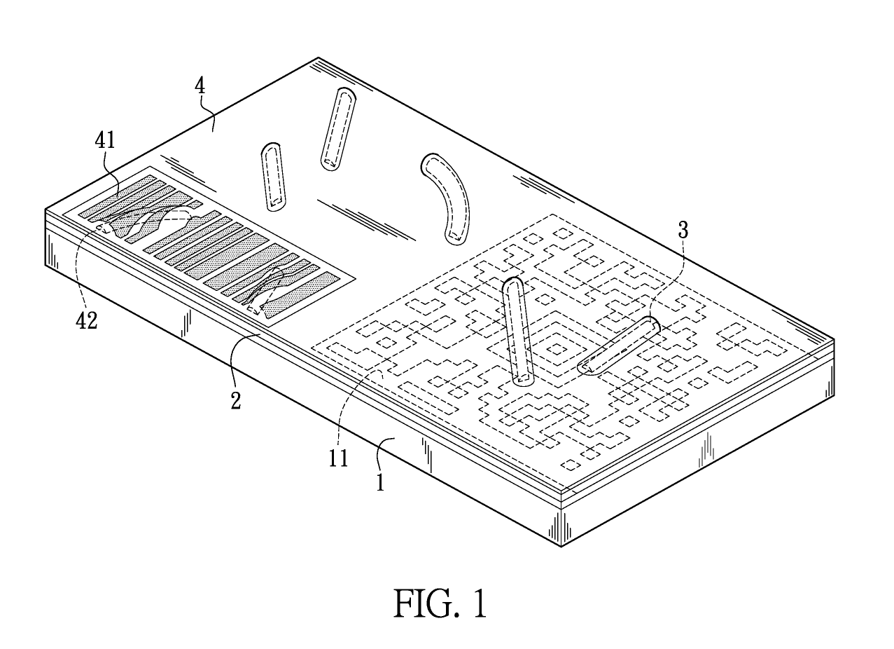

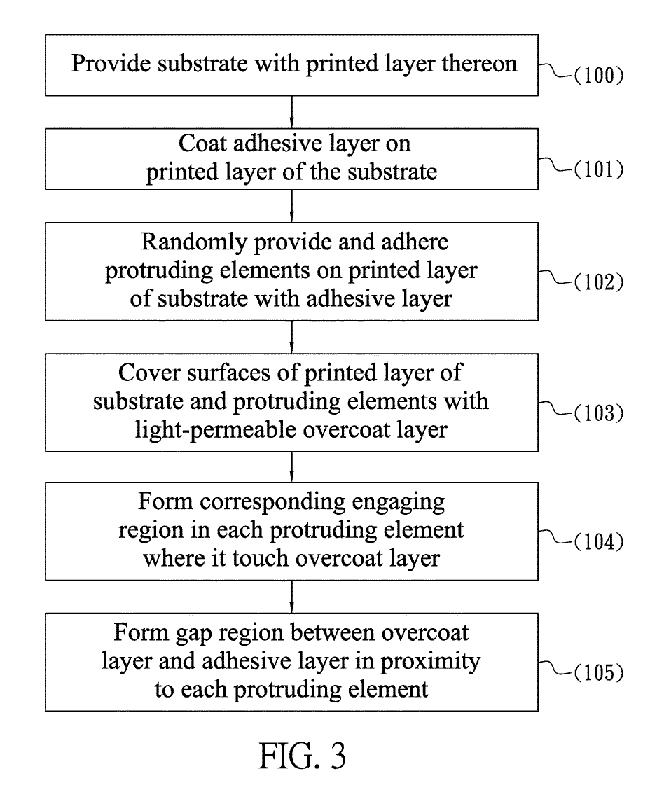

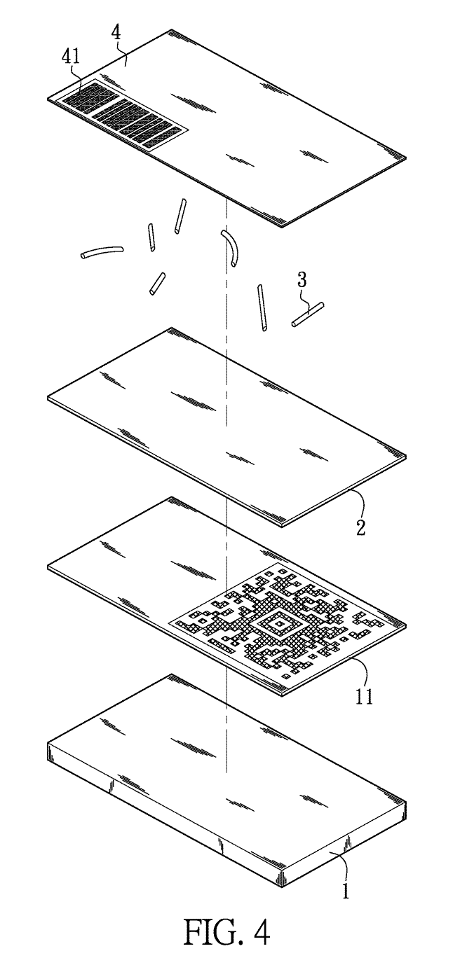

With reference to FIGS. 1 to 6, a structure in accordance with the present invention mainly includes: a substrate 1, an adhesive layer 2, protruding elements 3 and a light-permeable overcoat layer 4.

A printed layer 11 is provided on the surface of the substrate 1. The substrate 1 herein generally refers to anything that is formed into a flat shape or a sheet using materials such as paper, plastic, wood or fabrics. The printed layer 11 herein generally refers to patterns such as pictures, texts, or barcodes provided on the surface of the substrate 1 using a printing equipment. In a preferred embodiment, the substrate 1 and the printed layer 11 are in the form of a label, that is, the printed layer 11 on the surface of the substrate 1 can be one or more pictures or texts, such as a company's name, a product's name or data, a table, the price of a product and the like. An adhesive is provided on the other surface of the substrate 1 to allow the substrate 1 in the form of a label to be affixed to a desired location, such as on the surface of a product, a product package, a document, a book, a certificate, an ID or the like. Moreover, the printed layer 11 further includes a graphic area and a barcode area. The graphic area may be one or more pictures, texts or symbols for describing or advertising the product or serving as an additional planar anti-forgery identification, providing consumers with an initial understanding of the product using the graphic area. The barcode area can be any type of barcode structures such as a 2D code, a QR code, a Data Matrix code and the like. Upon analyzing the barcode, information fur connecting to a default data storage device can be provided so that the consumer is able to obtain anti-forgery information for authenticating the product.

The adhesive layer 2 can be coated onto the printed layer 11 of the substrate 1. It should be noted that the adhesive layer 2 herein generally refers to an adhesive applied onto the surface of the printed layer 11 of the substrate 1, so that the overcoat layer and the protruding elements can be attached thereto. In regards to the conventional laminating processes, a preferred embodiment is an on-site laminating technique that coats the printed layer 11 of the substrate 1 with a curable adhesive such as a UV curable adhesive, and performs UV curing once the manufacturing of the label is completed; and another embodiment is a pre-coated laminating technique in which the overcoat layer 4 is pre-coated with a hot-melt or heat-activated adhesive. The label is assembled by heating the hot-melt or heat-activated adhesive and subsequently applying pressure.

One or more protruding elements 3 are randomly distributed on the printed layer 11 of the substrate 1, and are adhered with the adhesive layer 2. The number and/or locations of the protruding elements 3 are randomly selected and scattered on the surface of the substrate 1. If the adhesive layer 2 is already provided on the substrate 1, the plurality of protruding elements 3 will be attached to the surface of the substrate 1 to prevent them from falling off. In other words, the protruding elements 3 can be secured on the printed layer 11 of the substrate 1 through the on-site laminating technique or the pre-coated laminating technique.

Each of the protruding elements 3 can be a geometric 3D element of a regular shape (e.g. with the shape of a granule, a bump, a tube, a stripe, or a column) or an irregular shape. The sizes of protruding elements 3 are such that they allow direct visual and tactile recognition of their quantity, locations and shapes, that is, they form height differences with respect to the surface of the substrate 1 so as to convey the feeling of protrusions when touched by a person. It should be noted that the protruding elements 3 can also be provided in accordance with the specification of the Braille system. The size, pitch, kerning, line spacing, and the like of the Braille bumps are set based on physiological and psychological characteristics of blind people. The shape of the bumps is usually hemispherical or parabolic,. The diameter of the bottom of the bump is between 1 and 1.6 mm with a height of 0.2˜0.5 mm. It should be noted that although the protruding elements 3 are herein described with reference to the configuration and arrangement of Braille, the protruding elements 3 are only not limited to those defined by the Braille system. Meanwhile, the protruding elements 3 may further exhibit color- or light-changing property (e.g. color-changing fluorescence response in certain fluorescent conditions at specific wavelengths), as well as magnetic, thermochromic, biometrics authentication (DNA) or other anti-forgery properties.

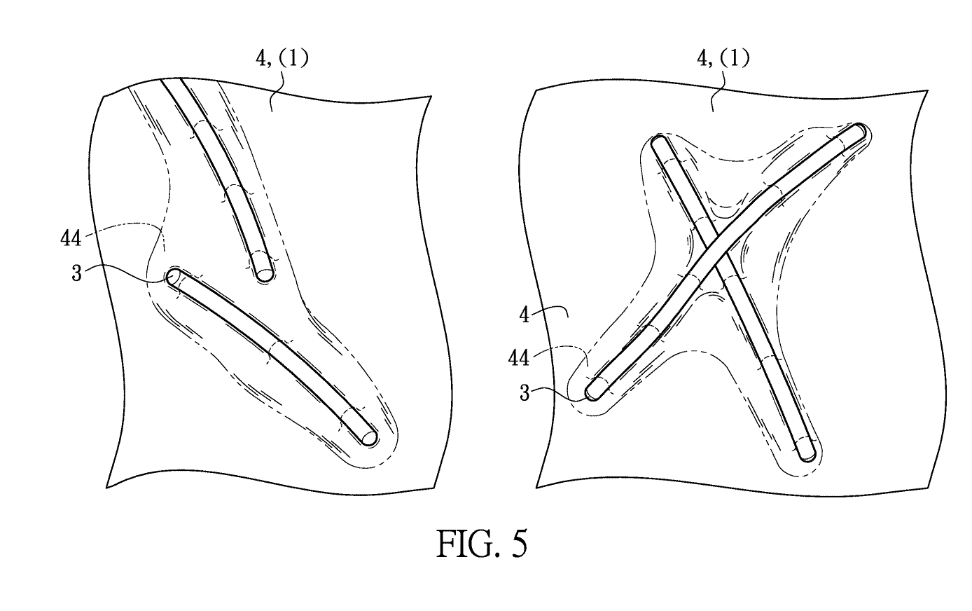

The overcoat layer 4 covers the surfaces of the printed layer 11 of the substrate 1 and the protruding elements 3. FIG. 5 shows two overcoat layers and their underlying substrates (labelled as 4, (1) in the drawing). A preferred embodiment of the overcoat layer 4 is a transparent PE/PEI/PP(BOPP) film with a preferred thickness below 0.3 mm (typically with a thickness of 1.5, 3, 5, 7, or 10 mil) to allow the tactile sensation of the protruding elements 3 as well as to let light pass through. The overcoat layer 4 is stretched by a tension mechanism (e.g. a laminator) to create tension and is then covered and positioned on the surfaces of the printed layer 11 of the substrate 1 and the protruding elements 3. After this, pressure is applied to secure the overcoat layer 4 and the protruding elements 3 on the surface of the printed layer 11 of the substrate 1. As such, a corresponding engaging region 43 is formed in each of the protruding elements 3 where it is in contact with the overcoat layer 4. A gap region 44 is formed between the overcoat layer 4 and the adhesive layer 2 in proximity to each of the protruding elements 3. The gap regions 44 may in communication with one another due to the proximity connecting or crisscrossing of the protruding elements 3 (referring to FIG. 5), thereby forming a common gap region 44. A printed area 41 is provided on the surface of the overcoat layer 4. A deformed region 42 is formed where the printed area 41 and an engaging region 43 overlap.

The method for manufacturing an anti-forgery label using random protruding elements includes the following steps. It should be noted that the descriptions of the relevant elements (the substrate 1 the adhesive layer 2, the protruding elements 3, and the light-permeable overcoat layer 4) are provided in the previous two paragraphs, and will not be repeated below.

(100) A substrate with a printed layer thereon is provided;

(101) An adhesive layer is coated on the printed layer of the substrate;

(102) A plurality of protruding elements are disposed and adhered onto the printed layer of the substrate with the adhesive layer;

In the above step, randomly disposing means that when the protruding elements are provided on the printed layers 11 of substrates 1, the quantity of the protruding elements 3 allocated to each of the substrates 1 may not necessarily be the same; the locations and angles of the protruding elements 3 attached on each of the substrates 1 may also be different. In an automated manufacturing process, the protruding elements 3 are first fed into a dispenser by picking them up or by vibration, and are then dispensed onto the substrate surface. In this case, the speed at which the protruding elements 3 are fed into the dispenser can be controlled by a random algorithm, resulting in random number of protruding elements 3 being provided to the dispenser. Furthermore, the speed at which the protruding elements 3 are discharged out of dispenser can also be controlled by a random algorithm to achieve random quantity and random distribution of the protruding elements 3 on the substrate 1. Alternatively, the protruding elements 3 can be manually and randomly distributed on the printed layer 11 of the substrate 1.

(103) A light-permeable overcoat layer is laid on the surfaces of the printed layer of the substrate and the protruding elements;

(104) An engaging region is formed in each one of the protruding elements where it is in contact with the overcoat layer; and

(105) A gap region is formed between the overcoat layer and the adhesive layer in proximity to each of the protruding elements.

In the above step, the overcoat layer 4 is stretched by a tension mechanism to create tension, and is then covered and positioned on the surfaces of the printed layer 11 of the substrate 1 and the protruding elements 3. Subsequently, pressure is applied to secure the overcoat layer 4 and the protruding elements 3 on the surface of the printed layer 11 of the substrate 1. An automated implementation involves the use of a laminator to perform a lamination process.

A printed area 41 is provided on the overcoat layer 4. A deformed region 42 is formed where the printed area 41 overlaps an engaging region 43. When the overcoat layer 4 is not assembled onto the substrate 1, the printed area 41 is an area of pictures, texts, barcodes, etc. without deformation. When the overcoat layer 4 is combined onto the substrate 1, the bottom of a part of the printed area 41 comes into contact with a protruding element 3 (that is, an engaging region 43), and that part of the printed area 41 becomes deformed. Compared to the overcoat layer 4 before assembly, the deformations of the pictures, texts, barcodes, or etc. in the deformed regions are noticeable (referring to FIG. 1, where a difference between the non-deformed part of the primed area 41 and the deformed regions 42 can be noticed). The changes in the deformed regions 42 can be used a characteristic marking for additional anti-forgery mechanism. Moreover, the printed, area 41 can be printed on the surface of the printed area 41 by a printing equipment before the overcoat layer 4 is assembled to the substrate 1, or after the overcoat layer 4 is assembled to the substrate 1. If the latter is performed, during the printing process of the printed area 41 by the printing equipment, the ink will have irregular distributions and changes due to the underlying protruding elements 3, further assisting in the anti-forgery feature of the deformed regions 42.

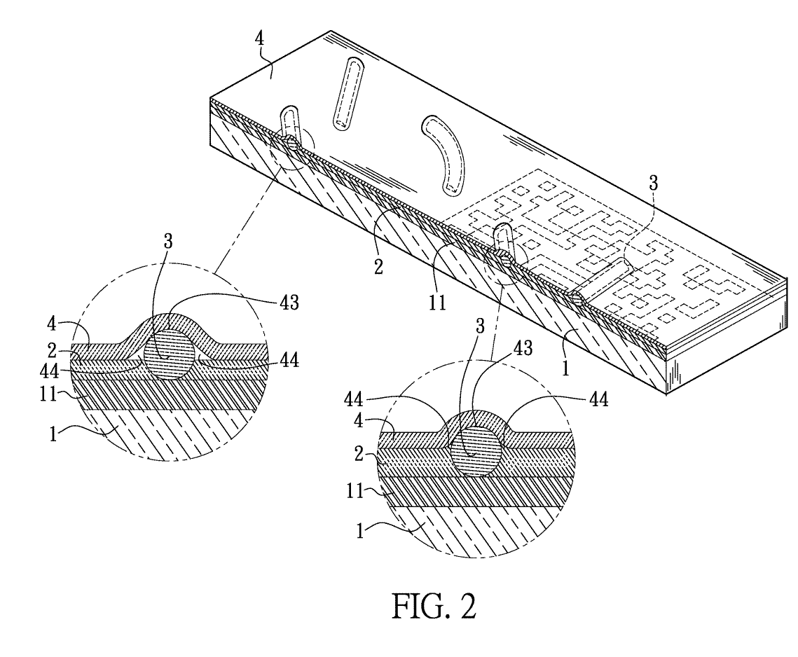

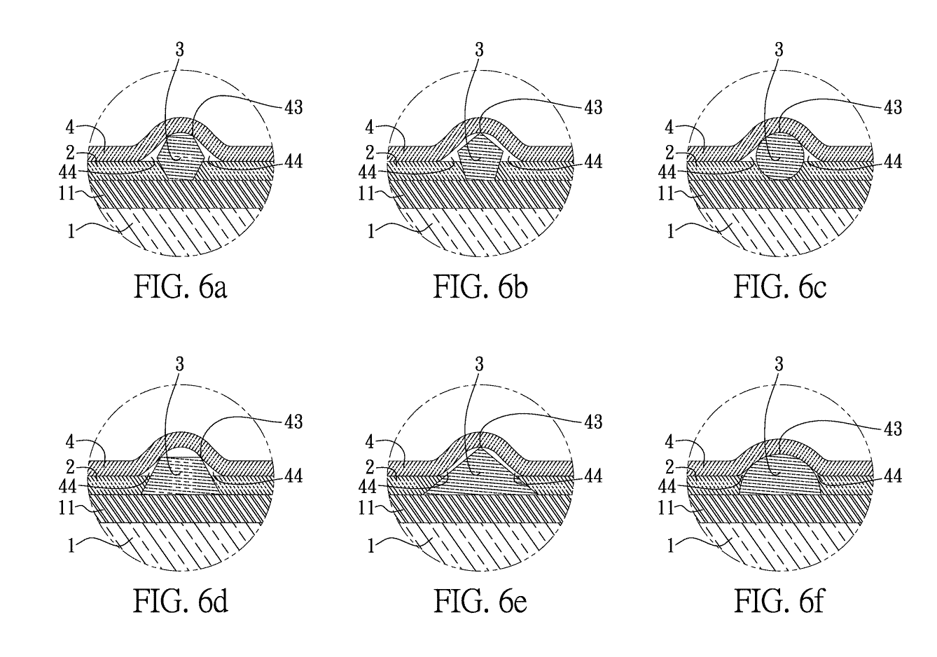

Referring to FIG. 2 and FIGS. 6a to 6f, it can be seen from the diagrams that, since the stress experienced by the substrate 1, the adhesive layer 2, the protruding elements 3 and the overcoat layer 4 may vary during the lamination process, the gap regions 44 would be randomly deformed such that they may be hollow (such as that shown in the left circle of FIG. 2) or solid (i.e. filled with adhesive of the adhesive layer 2, such as that shown in the right circle of FIG. 2). More specifically, the cross-section of a protruding element 3 is preferably in the shape of a circle, a square or a polygon. When such a rod or column is provided on the surface of the substrate 1, the bottom will be in contact with the substrate, and a gap region may be formed between the face is extending from the bottom periphery of the protruding element 3 and the substrate, whereas the overcoat layer 4 will not be able to cover the protruding element 3 near the surface of the substrate 1, thus forming a gap region 4. Another embodiment uses a triangular column, and whether a gap region 4 is formed would depend on the angles of the triangular column, the tension on the overcoat layer 4, the shape and the size of the pressure machine and the speed of lamination, thereby creating more randomness. Moreover, the adhesive used for the adhesive layer 2 may be a pressure-sensitive glue or a glue containing pressure-sensitive pigment granules that upon the application of pressure will burst and create color changes. In this case, the glue in a gap region 44 will retain its original color as it is not under pressure. In another embodiment, the light transmittance or color of the glue for the adhesive layer 2 may vary depending on its thickness (e.g. a pale blue glue appears transparent when it is very thin). The lamination process would change the thickness of the adhesive layer 2 (pressing it into the substrate 1), such that the areas of the adhesive layer 2 being laminated will have a lighter color, and the un-laminated adhesive in the gap regions 44 will have a darker color, thus creating a visual contrast.

In view of the above structures and steps, the present invention includes the following characteristics:

1. Since every protruding element 3 may be different in shapes and sizes, and the quantity and locations of the protruding elements 3 allocated to each substrate 1 may be different, the randomly disposed protruding elements 3 provide both tactile and visual identifications, alleviating the shortcoming of using photographic reproduction technique to create visual imitations, thus improving the effect of anti-forgery.

2. There are engaging regions 43 and gap regions 44 between the substrate 1, the protruding elements 3 and the overcoat layer 4, and these engaging regions 43 and gap regions 44 may be different as every protruding, element 3 may be different in shapes and sizes, and the quantity and locations of the protruding elements 3 allocated to each substrate 1 may be different. The formation of the gap region 44 involves a combination of the substrate 1, the adhesive layer 2 and the overcoat layer 4. Such structures make it difficult to counterfeit them through photography or 3D printing. In addition, as the angles of light passing through the gap regions 44 and the substrate 1 are different, this creates variations in light transmittance and thus visual differences. Moreover, since air is enclosed inside the gap regions 44 the hardness and tactile feedbacks of these regions are different from those of the substrate 1 and the protruding elements 3, thus creating tactile differences. Furthermore, the gap regions 44 are irregular regions formed as a result of the manufacturing process, they are not fixed elements that can be prepared in advance and controlled, making replications more difficult. In addition, the protruding elements 3 may crisscross or near one another, resulting in a common gap region formed of several protruding elements 3 with an even higher degree of irregularity, further increasing the difficulty in counterfeiting.

3. In view of the second point above, the gap regions 44 are randomly deformed during the lamination process as the stress experienced by the substrate 1, the adhesive layer 2, the protruding elements 3 and the overcoat layer 4 vary, such that they may become hollow (hollow gap regions 44) or solid (i.e. filled with adhesive of the adhesive layer 2). Anti-forgery can be further enhanced through variations created during the printing, adhesion and lamination processes. Since every protruding element 3 may be different in shape and size, the stress experienced by the overcoat layer 4 during lamination is also different, and each protruding element 3, the overcoat layer 4 and the adhesive layer 2 create different deformations, and the shape and size of the hollow region or the solid region near each protruding element 3 may be different. As such, not only is it not possible to fake such a label simply by photography and printout, neither is it possible to produce the exact random hollow regions by 3D printing.

4. Deformed regions 42 are formed where the printed area 41 of the overcoat layer 4 overlaps the engaging regions 43. Since every protruding element 3 may be different in shape and size, and the quantity and locations of the protruding elements 3 allocated to each substrate 1 may be different, the deformed regions 42 of each anti-forgery label may be different. The irregular shapes of the deformed regions 42 formed as a result of the manufacturing process further improve the effect of anti-forgery.

5. Combining the above characteristics together, each anti forgery label with random protruding elements has protruding elements 3 of different shapes and sizes, and the engaging regions 43 the gap regions 44, the hollow regions, the solid regions and the deformed regions 42 formed with respect to each protruding element 3, the substrate 1 and the overcoat layer 4 are all different, thus providing the anti-forgery labels with multiple tactile and visual identification features.

In summary, the anti-forgery label using random protruding elements and the method for manufacturing the same of the present invention achieves multiple tactile and visual identification features by providing randomly disposed protruding elements and irregular-shaped identification regions on the label. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. An anti-forgery label using random protruding elements, comprising:
a substrate with a printed layer thereon;
an adhesive layer coated on the printed layer of the substrate;
one or more protruding elements randomly disposed and adhered on the printed layer of the substrate with the adhesive layer; and
a light-permeable overcoat layer covering the surfaces of the printed layer of the substrate and the protruding elements, wherein a corresponding engaging region is formed in each of the protruding elements where the respective protruding element touches the overcoat layer, and a gap region is formed between the overcoat layer and the adhesive layer in proximity to each of the protruding elements.

2. The anti-forgery label using random protruding elements as claimed in claim 1, wherein a printed area is provided on the surface of the overcoat layer, and a deformed area is formed where the printed area overlaps each of the engaging regions.

3. The anti-forgery label using random protruding elements as claimed in claim 1, wherein the protruding elements are regular independent geometric three-dimensional elements or irregular independent three-dimensional elements.

4. The anti-forgery label using random protruding elements as claimed in claim 1, wherein some of the protruding elements further crisscross, overlap or are in proximity to one another to form the gap regions in communication with one another between these protruding elements.

5. The anti-forgery label using random protruding elements as claimed in claim 1, wherein the adhesive layer further includes pressure-sensitive particles.

6. A method for manufacturing an anti-forgery label using random protruding elements, comprising:
providing a substrate with a printed layer thereon;
coating an adhesive layer on the printed layer of the substrate;
randomly providing and adhering one or more protruding elements on the printed layer of the substrate with the adhesive layer;
covering the surfaces of the printed layer of the substrate and the protruding elements with a light-permeable overcoat layer;
forming a corresponding engaging region in each of the protruding elements where the respective protruding element touches the overcoat layer; and
forming a gap region between the overcoat layer and the adhesive layer in proximity to each of the protruding elements.

7. The method for manufacturing an anti-forgery label using random protruding elements as claimed in claim 6, wherein a printed area is provided on the surface of the overcoat layer, and a deformed area is formed where the printed area overlaps each of the engaging regions.

8. The method for manufacturing an anti-forgery label using random protruding elements as claimed in claim 6, wherein the protruding elements are regular independent geometric three-dimensional elements or irregular independent three-dimensional elements.

9. The method for manufacturing an anti-forgery label using random protruding elements as claimed in claim 6, wherein some of the protruding elements further crisscross, overlap or are in proximity to one another to form the gap regions in communication with one another between these protruding elements.

10. The method for manufacturing an anti-forgery label using random protruding elements as claimed in claim 6, wherein the adhesive layer further includes pressure-sensitive particles.
